(19) United States
(12) Patent Application Publication
(10) Pub. No.: US 2026/0043238 A1
(43) Pub. Date: Feb. 12, 2026

(54) STRUCTURAL OSB PANELS WITH INTEGRATED COMPRESSION RESISTANT FEATURES

(71) Applicant: LOUISIANA-PACIFIC CORPORATION, NASHVILLE, TN (US)

(72) Inventor: G. PAUL MERRICK, GIG HARBOR, WA (US)

(21) Appl. No.: 19/288,390

(22) Filed: Aug. 1, 2025

Related U.S. Application Data
(60) Provisional application No. 63/681,182, filed on Aug. 9, 2024.

(51) Int. Cl. E04C 2/52; B32B 37/18; B32B 37/24; E04B 1/66; E04C 2/16

(52) U.S. Cl. CPC E04C 2/523; B32B 37/18; E04B 1/665; E04C 2/16; B32B 2037/243

(57) ABSTRACT

A wood structural panel (such as oriented strand board, plywood, or other cellulosic panel) used for structural sheathing with one or more pre-applied weather resistant barriers or layers (WRBs) with integrated compression-resistant features. When installed, the integrated compression-resistant features provide an air space or channels the WRB layer and the exterior cladding. This allows drainage of rainwater or other moisture that otherwise become trapped between the cladding and WRB layer, thus providing extra protection for the structure. These features are applied at the factory during or immediately after the manufacturing of the structural sheathing panel with WRB layer, and thus are integrated therewith as part of the integrated finished product.

This application claims priority to and benefit of U.S. Provisional App. No. 63/681,182, filed Aug. 9, 2024, which is incorporated herein by specific reference in its entirety for all purposes.

### FIELD OF INVENTION

This invention relates to a wood structural panel (such as oriented strand board, plywood, or other cellulosic panel) used for structural sheathing with pre-applied weather resistant barriers or layer (WRBs). More particularly, this invention relates to structural sheathing panels with pre-applied WRBs with integrated compression resistant features.

### BACKGROUND OF INVENTION

Building wall and roof assemblies are typically layers of several materials, each performing a single function, that are installed separately on the site in which the building is being constructed. Compatibility between the various layers creates challenges not only for the designer, but also for the installers. Combining layers requires a suitable base layer in which additional layers can be applied to create a single wall or roof layer that has multiple functions.

Light frame construction typically utilizes wood or manufactured wood structural panel sheathing (e.g., OSB or plywood) that is fastened to the wall framing. Oriented, multilayer wood strand boards are composed of several layers of thin wood strands, which are wood particles having a length which is several times greater than their width. These strands are formed by slicing larger wood pieces so that the fiber elements in the strands are substantially parallel to the strand length. The strands in each layer are positioned relative to each other with their length in substantial parallel orientation and extending in a direction approaching a line which is parallel to one edge of the layer. The layers are positioned relative to each other with the oriented strands of adjacent layers perpendicular, forming a layer-to-layer cross-oriented strand pattern. Oriented, multilayer wood strand boards of the above-described type, and examples of processes for pressing and production thereof, are described in detail in U.S. Pat. Nos. 3,164,511, 4,364,984, 5,435,976, 5,470,631, 5,525,394, 5,718,786, and 6,461,743, all of which are incorporated herein in their entireties by specific reference for all purposes.

Following the sheathing, a weather resistant barrier (WRB) system is installed around the building. Often referred to as “house wraps,” these typically are available in separate roll form. and must be installed by the builder on site, often at great difficulty due to wind or other adverse weather conditions. These products are stapled or otherwise mechanically affixed to the sheathing at the job site, and thus necessarily puncture the WRB and often cause tearing of the WRB. And while some house wraps have raised features, these features generally are not sufficiently resistant to the compressive forces typical with installation of cladding or siding.

In high volume rain environments, a rainscreen system often is applied on site after and separate from application of the WRB, and may be required by local building codes The rainscreen system provides an air space between the WRB layer and the exterior cladding. This allows drainage of rainwater that may pass through the exterior cladding and may otherwise become trapped between the cladding and WRB layer, thus providing extra protection for the structure. However, these separate systems significantly add to the cost and labor for construction.

### BRIEF DESCRIPTION OF THE DRAWINGS

FIG. 1 shows a cutaway side view of a structural panel with integrated WRB and compression-resistant features installed on a wall frame.

FIGS. 2-14 show diagrams of steps to fabricate exemplary embodiments of the present invention.

FIGS. 15 and 16 shows front views of integrated raised feature patterns on the face of a sheathing or structural panel with WRB.

### DETAILED DESCRIPTION OF EXEMPLARY EMBODIMENTS

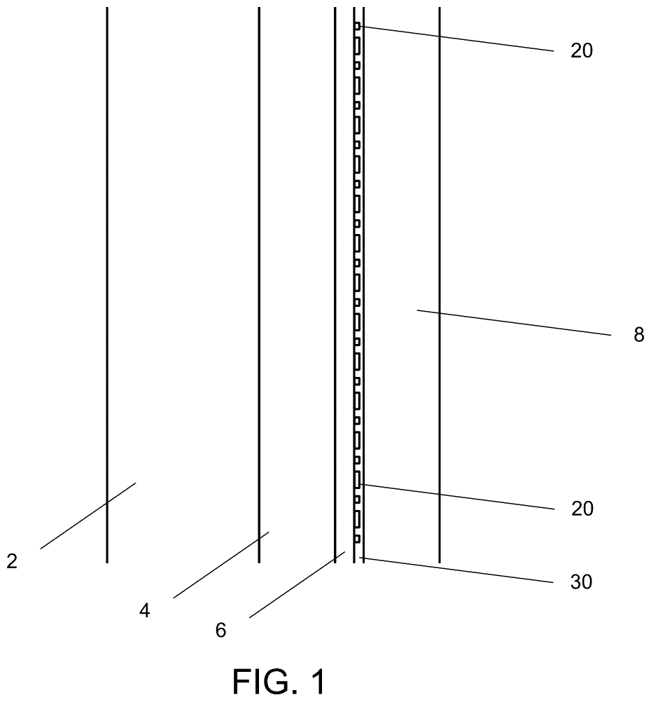

In various exemplary embodiments, as seen in FIG. 1, the present invention comprises a wood or manufactured wood structural and/or sheathing panel 4 with a pre-applied or integrated WRB layer 6, where the WRB layer 6 has a plurality of integrated compression-resistant, raised features (sometimes referred to as “rainscreen features”) 20, on the surface of the WRB or embedded in the WRB layer. In some embodiments, these features comprise raised polymer beads, which can be in various shapes or sizes, and arranged in a variety of patterns (such as, but not limited to, rows and columns) or styles. These rainscreen features 20 are applied at the factory during or immediately after the manufacturing of the sheathing panel 4 with WRB layer 6, and thus are integrated therewith as part of the finished product, which then can be supplied as an integrated, finished product to the end user (e.g., a builder or contractor).

FIG. 1 shows the integrated panel with WRB and rainscreen features mounted on one or more studs 2 or frame components of a building under construction. The integrated panel is mounted to the studs or framing by means of nails, screws, or similar fasteners (not shown). After the integrated panel is installed, cladding or siding 8 is placed over the outer face of the panel with WRB, and thus overlays the integrated raised rainscreen features 20.

These integrated compression-resistant features 20 provide a rainscreen gap 30 between the sheathing panel/WRB 4, 6 and the overlying siding or cladding 8 in a one-step process with installation of the sheathing. It provides for the positive drainage of liquid water or moisture that may become trapped between the sheathing panel/WRB layer and the siding or cladding. The present invention also may be used in those locations, such as coastal area subject to high winds, where the use of a WRB and a rain screen feature are required or otherwise used as a best practice. Further, the present invention also improves air flow behind the siding or cladding (i.e., in the gap 30), thereby promoting more efficient and effective removal of moisture or water vapor.

The present invention eliminates the separate job-site steps of first applying sheathing panels to a structure at a job site, then applying a WRB over the sheathing panels, then applying a rainscreen system over the WRB. Because the raised compression-resistant features are integrated with the WRB and sheathing panel, the sheathing panel, WRB and rainscreen system are effectively applied in a single step, thereby avoiding the additional cost, expense, and trouble of separate application at a job site.

In several embodiments, the present invention comprises a piece of structural sheathing (e.g., OSB meeting requirements of Standard PS-2) 4 to which a weather resistant house wrap or barrier layer (WRB) 6 is laminated, affixed or spray applied. This may be done before the primary pressing of the sheathing panel in the factory, immediately after the primary press, or in a secondary process at the factory. The compression-resistant raised features 20 similarly may be applied before or after the primary press or in a secondary process.

The application of the WRB 6 and the application of the raised features 20 may be performed sequentially at the same time or at different times (e.g., the WRB is applied before the sheathing panel undergoes primary pressing, while the raised features are applied after pressing). In some embodiments, the features are already present and integrated with or embedded in the WRB layer prior to the application of the WRB layer to the sheathing. The WRB layer with integrated rainscreen features then may be laminated or affixed to the panel substrate as described above.

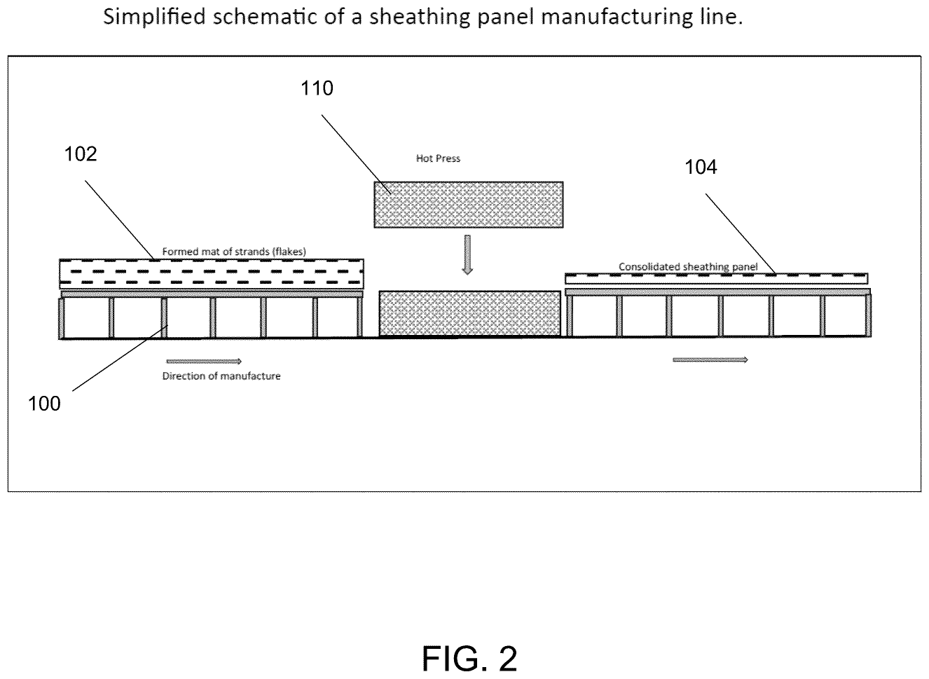

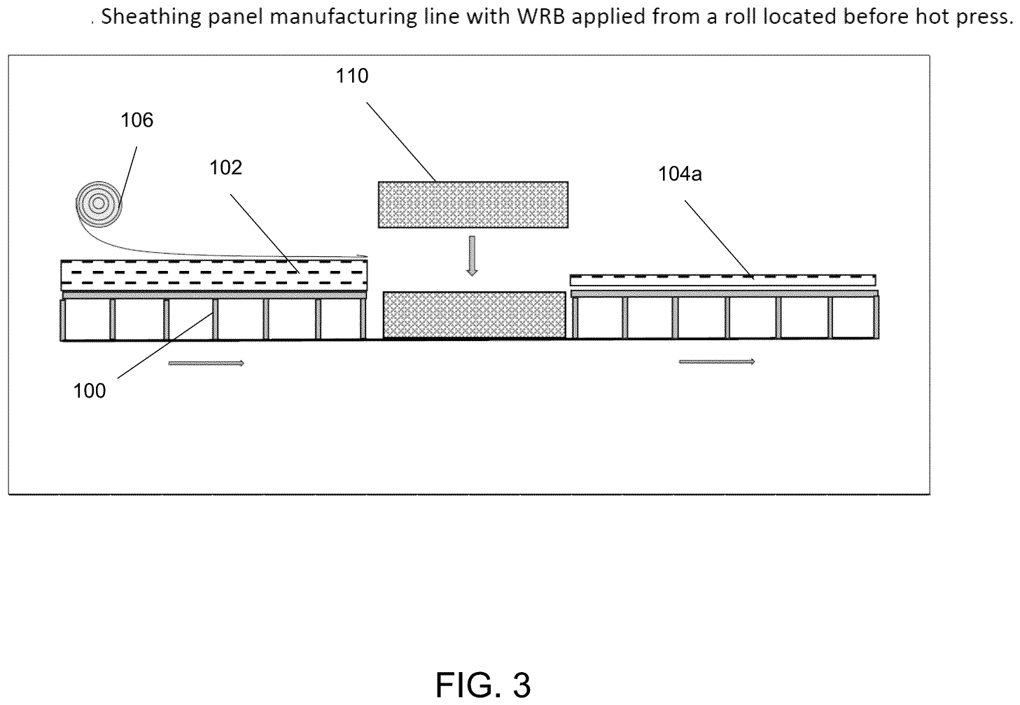

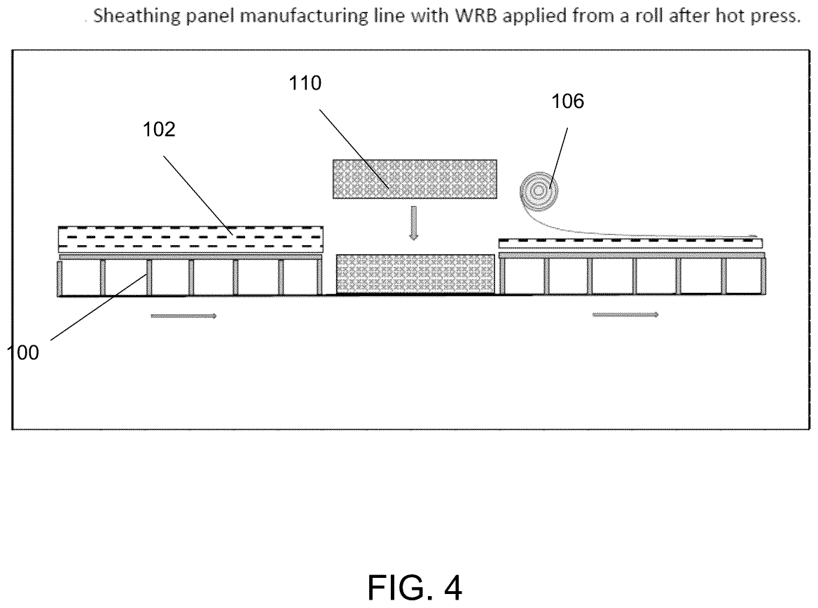

FIG. 2 shows a schematic of a sheathing or structural panel manufacturing production line. Wood strands or flakes are to form a strand mat 102 on a conveyor 100, which then undergoes the application of heat and pressure in a hot press 110 (which may be single stage but typically is multi-stage) to form a consolidated strand blank, board or panel 104. FIG. 3 shows a common variation of this process, where a WRB 106 is applied from a roll onto the upper surface of the strand mat 102 prior to pressing. The result of this process is a consolidated strand blank/board/panel with integrated WRB layer 104a. FIG. 4 shows another variation, where a WRB 106 is applied from a roll onto the upper surface of the consolidated strand blank/board/panel 104 after pressing.

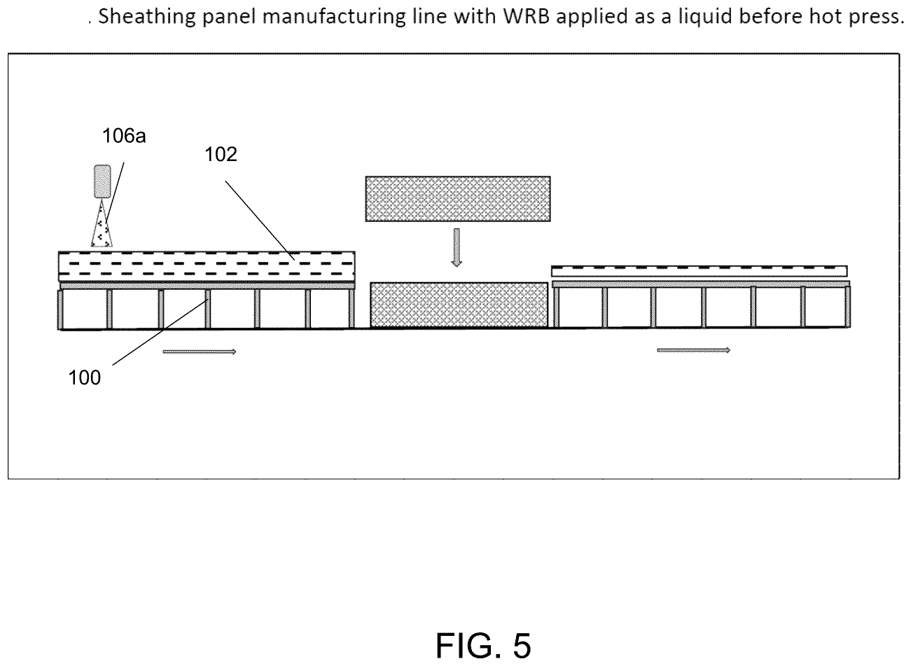

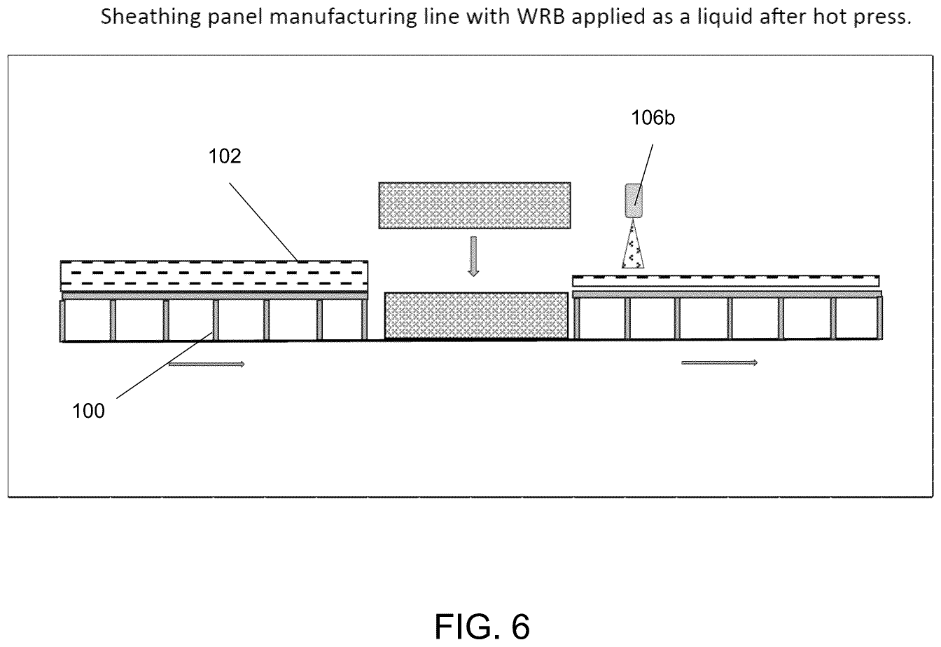

FIG. 5 shows yet another variation of this process, where a WRB in liquid form is spray-applied 106a onto the upper surface of the strand mat 102 pre-press. A fabric layer or similar material may be placed on the upper surface of the strand mat to receive the WRB in liquid form. The liquid WRB 106b can be spray-applied post-press in a secondary process, as well, as seen in FIG. 6.

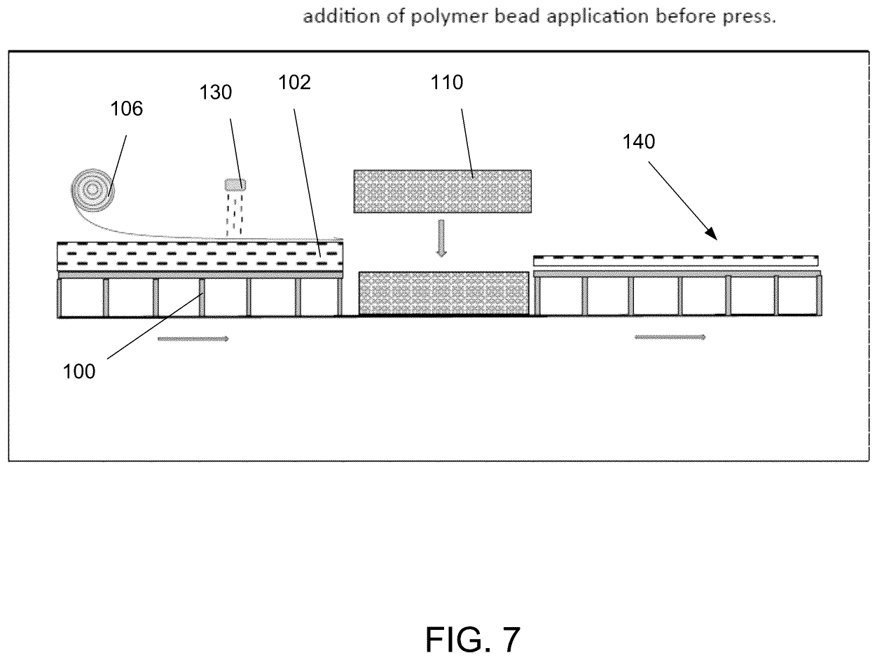

FIG. 7 shows a process where a WRB 106 is applied from a roll onto the upper surface of the strand mat 102 followed by the addition or application of polymer beads 130 to the upper surface of the WRB prior to pressing 110. This produces an integrated consolidated strand blank/board/panel with WRB and rainscreen features 140, as described above.

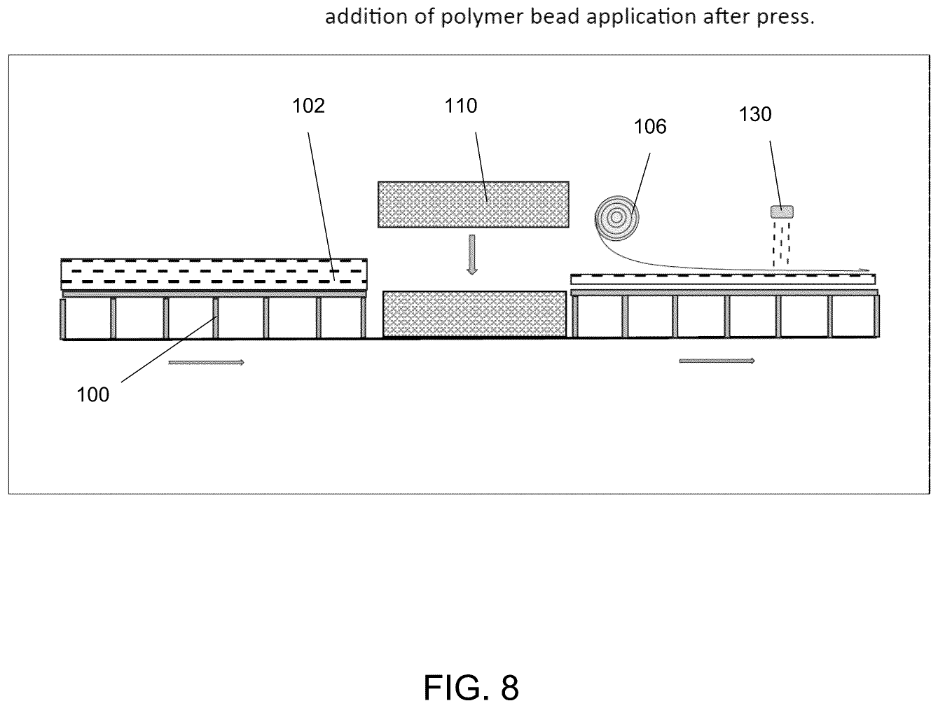

FIG. 8 shows a variation of this process where the WRB 106 and the addition or application of polymer beads occurs after primary pressing 110 (e.g., during a secondary process). The WRB and polymer beads are laminated to the consolidated strand blank/board/panel to form the integrated product.

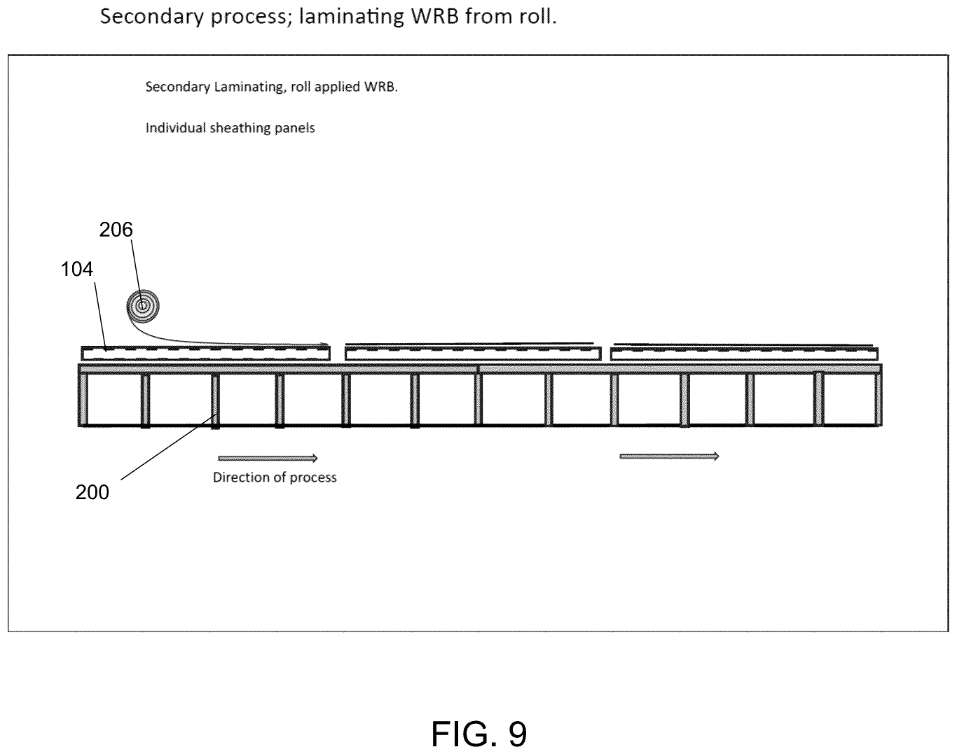

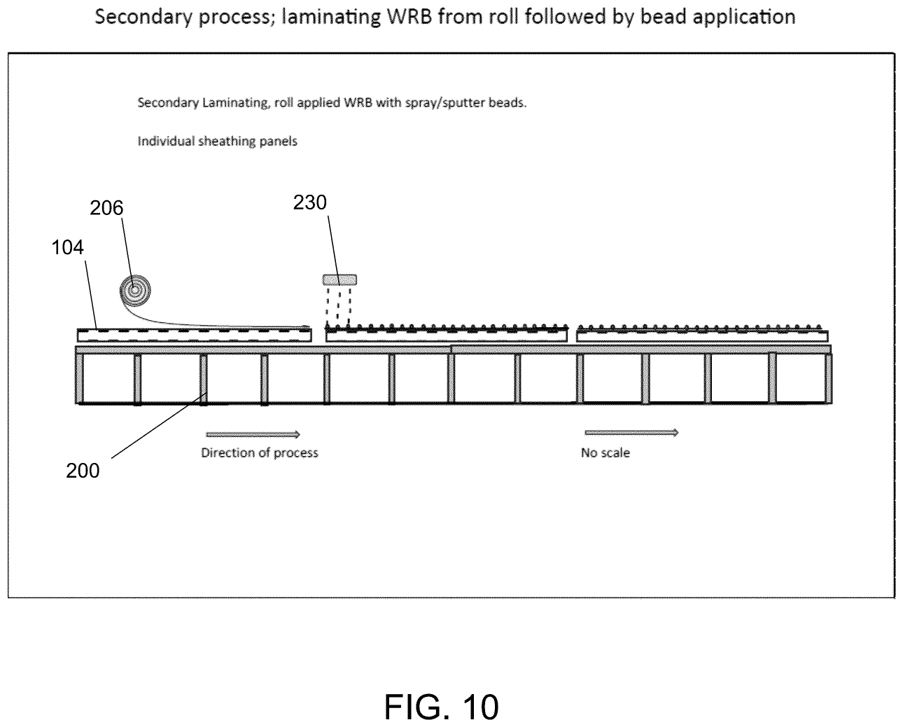

FIG. 9 shows secondary lamination process, where sections of a WRB (from a roll) 206 are applied to a series of consolidated strand blank, board or panels 104 that pass underneath the roll on a conveyor 200. Each section of WRB is cut off to match the corresponding panel. This panel may be a blank, “master panel”, or “jumbo panel” that is later cut into smaller panels after laminating. For example, a blank, master panel, or jumbo panel typically exits the primary press at 8′ wide×16′ long. In a secondary process a WRB is laminated to a surface, then the jumbo panel is cut into multiple standard-size panels of 4′ wide by 8′ long. Alternately, the jumbo panel may be cut to form the 4′×8′ standard-sized panels first and then WRB laminated. As seen in FIG. 10. a plurality of polymer beads 230 are then added or applied (e.g., sprayed, sputtered) to the top of the WRB, and then cured.

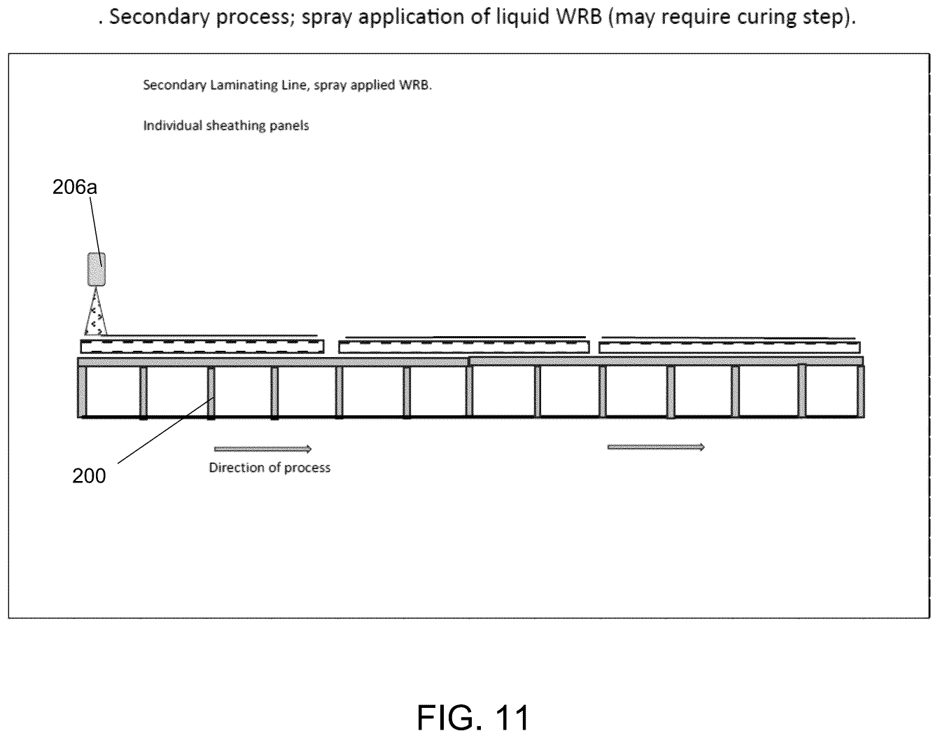

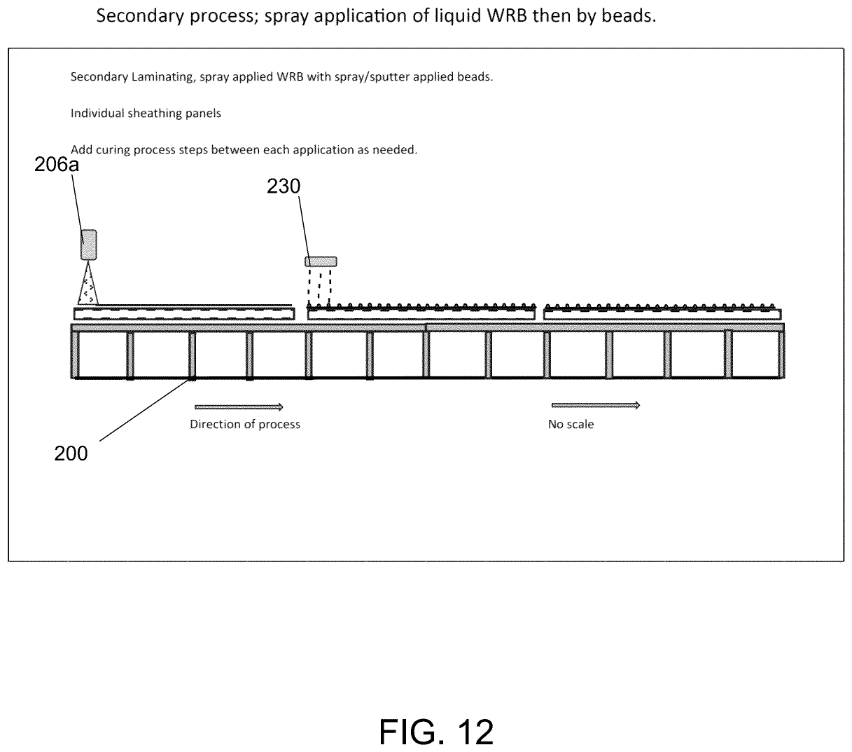

FIGS. 11 and 12 show a variation of this process, where the WRB is spray applied 206a. The polymer beads 230 are then added, the WRB and beads are then cured. Alternatively, the WRB may be cured after initial application and prior to the addition of the polymer beads.

In one exemplary embodiment, the raised rainscreen features are contained in a “sandwich” between two films that are laminated. This sandwich laminate protects the raised features from being dislodged during production, shipping, storage and application, thereby avoiding dislodgment problems common with prior art rainscreens. In one embodiment the sandwich laminate may be formed using a vacuum process where both laminates are preformed or fabric-like films. In an alternative embodiment, the bottom laminate is a fabric-like or fabric-based film, while the top laminate is a liquid-applied film applied over the bottom laminate and the raised features.

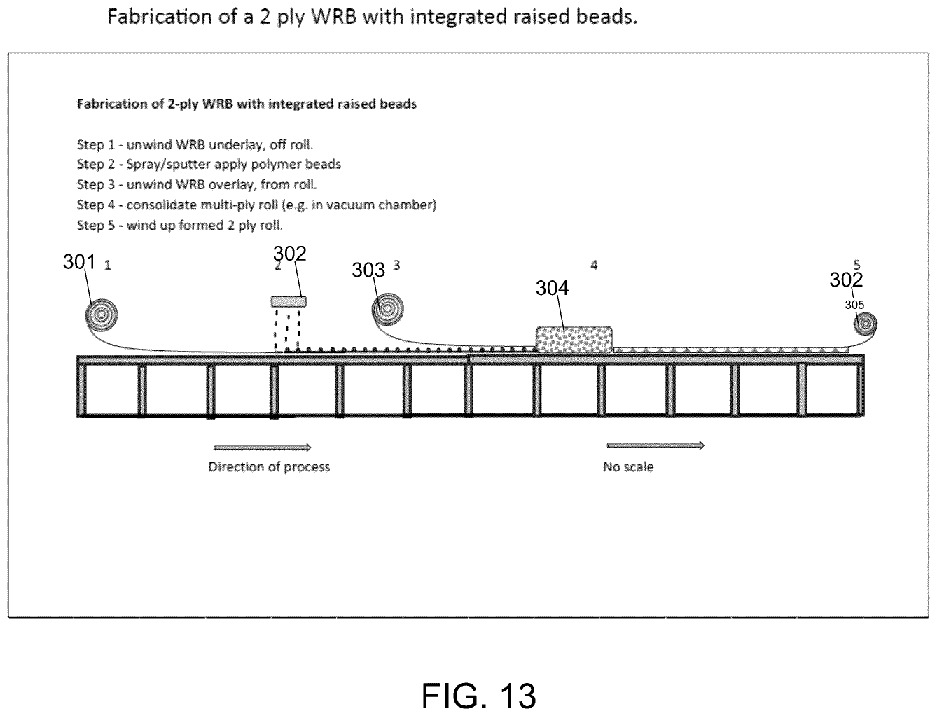

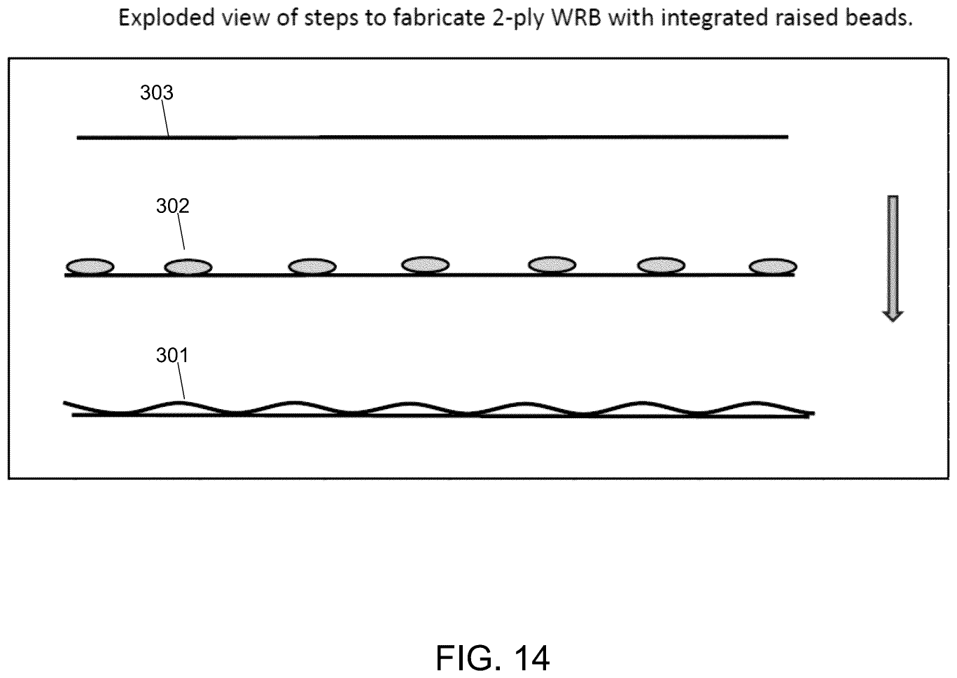

FIGS. 13 and 14 show a manufacturing process for fabricating such a “sandwich,” where the polymer beads are located between two WRB layers. First, the first WRB layer (an underlay) is unwound from a roll 301 onto on a conveyor. Then polymer beads are applied (e.g., sprayed. sputtered) 302 onto the first WRB overlay as it passes underneath. Next, the second WRB layer (an overlay) is unwound off of a roll 303 onto the first WRB overlay and beads. The WRB layers and polymer beads are then consolidated as a single multi-ply “sandwich”, which can be done in a vacuum chamber 304. The consolidated “sandwich” is then wound up into a roll 305, which may then be send to another manufacturing location where the multi-ply product may be applied to blanks, boards, or panels as described above.

In several embodiments, the raised features are a plurality of circular or elongated beads made from a compression-resistant polymer material (e.g., plastic, thermoplastic, polyethylene, polypropylene, polystyrene, and/or polyvinyl chloride) or a thermosetting resin (e.g., a liquid silicone rubber). In some embodiments, the raised features may be lines or line segments, which may be straight or curved. The beads may have a flat side, with a curved or semi-spherical upper face or side. When integrated with the WRB, the beads create a three-dimensional, raised platform against which a siding or cladding product can be overlain or attached. The polymer material may be selected to resist damage, dislodgment or removal during handling and installation, but resistant compressions sufficiently to remain functional when siding or cladding is attached. In several embodiments, the polymer material when applied as a raised feature has a Shore A hardness (on the Shore A standardized hardness scale which ranges from 0 to 100) of from approximately 10 to approximately 90, more preferably from approximately 30 to approximately 60, and most preferably from approximately 40 to approximately 50. In one embodiment, the raised features have a Shore A hardness in the range of 40 to 50.

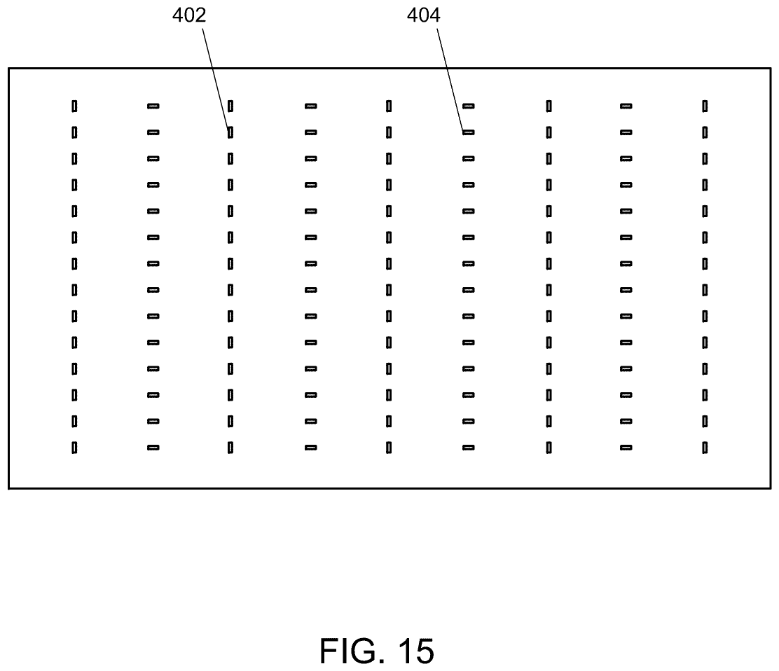

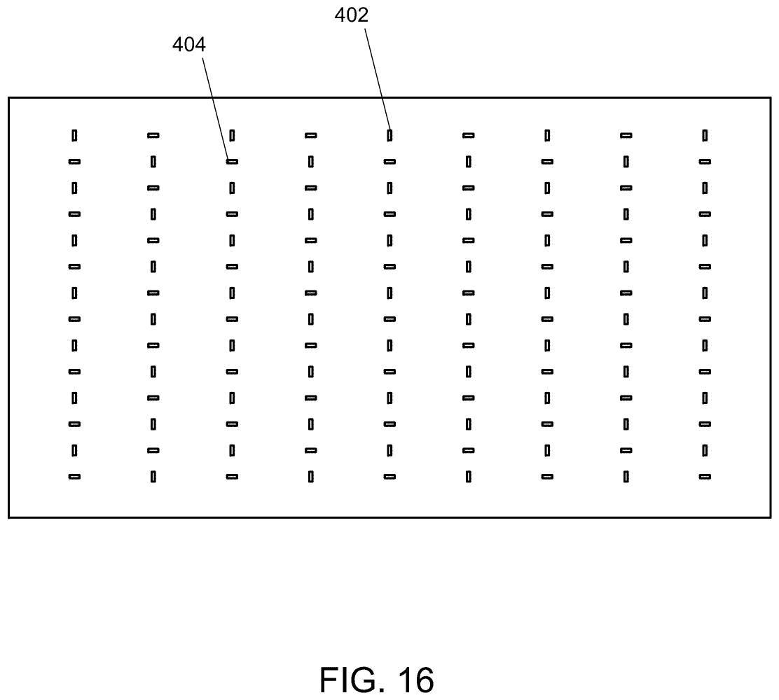

The features can be configured or arranged in any number of dimensions or patterns to optimize the drainage of free water and other forms of moisture that may get behind the cladding. Polymer beads 402, 404 may be distinctly separate (i.e., not attached to each other) or continuous (i.e., attached to each other). In some embodiments of the continuous form, the feature may have one or more relatively higher and one or more relatively lower sections that create a gap through which liquid moisture could drain. The raised features could be of various designs selected to ensure efficient movement of liquid moisture. More than one shape or design of raised feature could be used and the alignment or patterning of various raised features could be varied (e.g., a parallel grid pattern or curved or S-shaped patterns). Examples of patterns are shown in FIGS. 15 and 16.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A wood-based panel product, comprising:
a wood-based panel comprising a first face, a second face, a top edge, a bottom edge, a right edge, and a left edge;
a weather-resistant barrier (WRB) layer comprising an outer face and an inner face, said WRB affixed to the first face of the wood-based panel;
a first set of raised features comprising a plurality of raised elements projecting from the outer face; and
a second set of raised features comprising a plurality of raised elements projecting from the outer face;
wherein the first set of raised features has a Shore A hardness of from approximately 40 to approximately 50.

2. The wood-based panel product of claim 1, wherein the second set of raised features has a Shore A hardness of from approximately 40 to approximately 50.

3. The wood-based panel product of claim 2, wherein the first set of raised features has a Shore A hardness in a range from 40 to 50.

4. The wood-based panel product of claim 1, wherein the raised elements are attached to the outer face.

5. The wood-based panel product of claim 1, wherein the raised elements are integrated with the WRB layer.

6. The wood-based panel product of claim 1, wherein the raised elements are polymers.

7. The wood-based panel product of claim 1, wherein the first set of ventilation features and the second set of ventilation features are arranged to provide ventilation and drainage whether the panel is installed in a vertical or horizontal orientation.

8. The wood-based panel product of claim 1, wherein the first set of ventilation features are oriented at an angle to the second set of ventilation features.

9. The wood-based panel product of claim 1, wherein the first set of ventilation features and the second set of ventilation features overlap at least in part.

10. The wood-based panel product of claim 1, wherein the first set of ventilation features and the second set of ventilation features are arranged to provide ventilation and drainage whether the panel product is installed in a vertical or horizontal orientation.

11. The wood-based panel product of claim 1, wherein the panel is a structural sheathing panel.

12. The wood-based panel product of claim 1, wherein the first face is an outward facing face of the panel.

13. A method for producing an integrated wood-based panel product, comprising the steps of:
forming, on a production line, a bottom layer of a mat from bottom strands in a bottom layer orientation, wherein the bottom strands have been treated with one or more adhesives;
after forming the bottom layer, forming, on the production line, a core layer of the mat from core strands in a core layer orientation, wherein the core strands have been treated with one or more adhesives, and wherein the core layer orientation is different from the bottom layer orientation;
after forming the core layer, forming, on the production line, a top layer of the mat from top strands in a top strand orientation, wherein the top strands have been treated with one or more adhesives;
after forming the top layer, applying, on the production line, a weather-resistant barrier (WRB) layer on an upper surface of the top layer;
consolidating and bonding the bottom strand layer, core strand layer, top strand layer, and WRB layer together in a primary press using heat and pressure to form a master blank;
applying, in a secondary production process, a first plurality of raised elements to an upper surface of the WRB layer of the master blank; and
cutting the master blank into two or more integrated panels, wherein each of said two or more integrated panels include the respective strand layers, the respective WRB layer, and the respective first plurality of raised elements pre-formed into an integral multi-layer arrangement.

14. The method of claim 13, wherein the secondary production process comprises a vacuum process.

15. The method of claim 13, wherein the step of applying a first plurality of raised elements comprises obtaining a pre-fabricated arrangement of polymer beads contained between a bottom laminate and a top laminate.

16. The method of claim 15, wherein the bottom laminate is a fabric-like or fabric-based film.

17. The method of claim 15, wherein the top laminate is a liquid-applied film.
